(19) United States
(12) Patent Application Publication
(10) Pub. No.: US 2021/0171084 A1
(43) Pub. Date: Jun. 10, 2021

(54) SLED FOR SANDY TERRAIN

(71) Applicants: Richard Bankhead, Downey, CA (US); Darryl Bradley, Downey, CA (US)

(72) Inventors: Richard Bankhead, Downey, CA (US); Darryl Bradley, Downey, CA (US)

(21) Appl. No.: 16/705,155

(22) Filed: Dec. 5, 2019

(51) Int. Cl. B62B 15/00

(52) U.S. Cl. CPC B62B 15/007; B62B 2501/065; B62B 2202/52; B62B 15/008

(57) ABSTRACT

An illustrated view of an exemplary sled for transporting items across difficult terrain is presented. The sled is useful for providing a means to transport belongings across a flat hard terrain to a desired location in an efficient and easy manner.

### FIELD OF THE INVENTION

This invention relates to sleds. More particularly, it relates to sleds utilized on sandy terrains.

### BACKGROUND

A cart is a vehicle designed for transport, using two wheels and normally pulled by one or a pair of draught animals. A handcart is pulled or pushed by one or more people. It is different from a dray or wagon, which is a heavy transport vehicle with four wheels and typically two or more horses, or a carriage, which is used exclusively for transporting humans.

A sled, sledge, or sleigh is a land vehicle that slides across the surface, usually of ice or snow. It is built with either a smooth underside or a separate body supported by two or more smooth, relatively narrow, longitudinal runners similar in principle to skis. This reduces the amount of friction, which helps to carry heavy loads.

Some designs are used to transport passengers or cargo across relatively level ground. Others are designed to go downhill for recreation, particularly by children, or competition. (Compare cross-country skiing with its downhill cousin.) Shades of meaning differentiating the three terms often reflect regional variations depending on historical uses and prevailing climate.

Sleigh refers to a moderate to large-sized, usually open-topped vehicle to carry passengers or goods, and typically drawn by horses, dogs, or reindeer.

In American usage sled remains the general term but often implies a smaller device, often for recreational use. Sledge implies a heavier sled used for moving freight or massive objects.

Sleds are especially useful in winter but can also be drawn over wet fields, muddy roads, and even hard ground if one helps them along by greasing the blades with oil or alternatively wetting them with water. For an explanation of why sleds and other objects glide with various degrees of friction ranging from very little to fairly little friction on ice, icy snow, wet snow, and dry snow, see the relevant sections in the articles on ice and ice skating. The traditional explanation of the pressure of sleds on the snow or ice producing a thin film of water and this enabling sled to move on ice with little friction is incorrect.

Carts and sleds both have problems while be taken over a sandy location such as a beach. The wheels of the carts may become lodged into the sand and thus unable to move, specially when weight is added to the cart. Sleds are difficult in sandy areas because when weight is added it becomes more difficult to pull to a desired location and animals to pull the sled are normally not allowed in the sandy locations.

In light of the above, it would be desirable to have an apparatus the combines the beneficiary aspects of a sled and a cart for transporting items across sandy locations.

### BRIEF DESCRIPTION OF THE DRAWINGS

FIG. 1 is an illustrated view of an exemplary sled.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

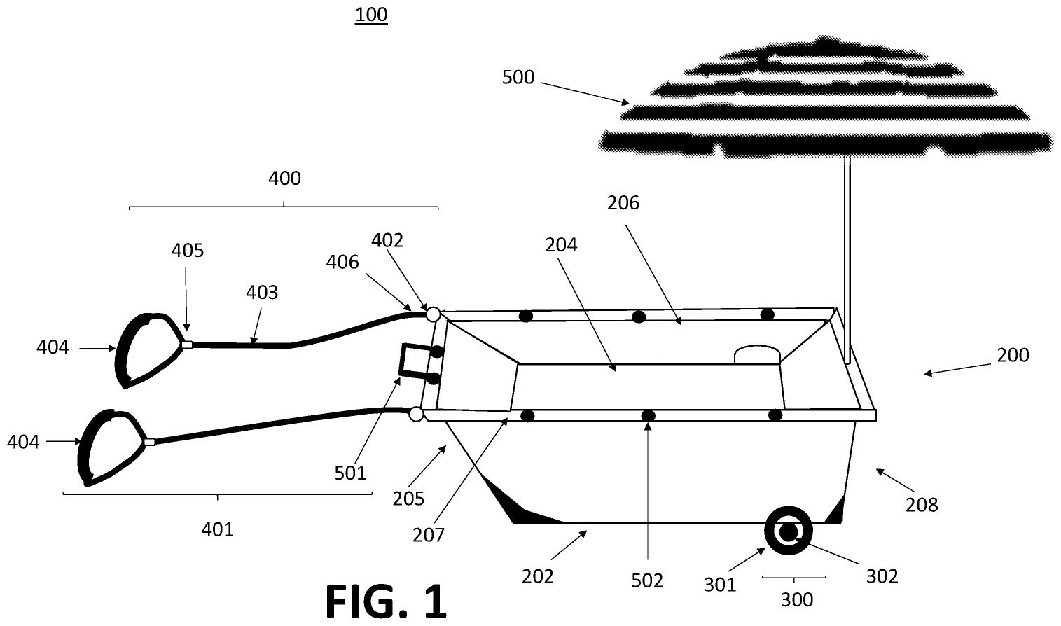

Referring to FIG. 1, an illustrated view of an exemplary sled 100 for transporting items across difficult terrain is presented. The sled 100 is useful for providing a means to transport belongings across a sandy beach to a desired location in an efficient and easy manner.

The sled 100 preferably has a height of eighteen (18) inches, however other heights are hereby contemplated, including, but not limited to, fifteen (15) inches, twenty (20) inches, etc. The sled 100 preferably has a length of three (3) feet, however other lengths are hereby contemplated, including, but not limited to, two and one-half (2.5) feet, four (4) feet, etc. The sled 100 preferably has a width of two (2) feet, however other widths are hereby contemplated, including, but not limited to, one and one-half (1.5) feet, three (3) feet, etc.

The sled 100 preferably has a shape being rectangular, however other shapes are hereby contemplated, including, but not limited to, trapezoidal, square, oblong, etc. The sled 100 is preferably made of a plastic material, however other materials are hereby contemplated, including, but not limited to, metal, such as aluminum, steel, etc., poly-vinyl chloride (PVC), etc.

The sled 100 has a body 200, a wheel assembly 300 and a assembly 400.

The body 200 of the sled 100 has a bottom 202, an interior 204, a front 205, a top 206, an edging 207 and a back 208.

The interior 204 of the body 200 is useful for storing and carrying items for later use at a desired location. The interior 204 of the body 200 is substantially hollow. The items are preferably beach items, however other items are hereby contemplated, including, but not limited to, garden equipment, plants, etc. The beach items are preferably a cooler, swim wear, scuba equipment, towels, etc.

Optionally and/or additionally, an umbrella 500 is coupled to the edge 207 substantially near the back 202 of the body 200 of the sled 100. The umbrella 500 is removably coupled to the body 200 of the sled 100 by a coupling device, such as an umbrella hole, a clamp, a clip, Velcro® straps, etc. The umbrella 500 is useful for providing shade for the items stored in the interior 204 of the body 200. The umbrella 500 can further be removed from the sled 100 for use outside of the use of the sled 100. The umbrella 500 is preferably a beach umbrella, however other types of umbrellas are hereby contemplated, including, but not limited to, foldable, storm, golf, etc.

The wheel assembly 300 has one or more wheels 301 and an axle 302. The wheel 301 is preferably a solid wheel, however other types of wheels are hereby contemplated, including, but not limited to, air-filled wheel, traction belt wheel, etc. The axle 302 is preferably made of an aluminum material, however other materials are hereby contemplated, including, but not limited to, poly-vinyl chloride (PVC), plastic, steel, etc.

The wheels 301 of the wheel assembly 300 is coupled to the axle 302. The wheel assembly 300 is further securely coupled to substantially near the back 208 on the bottom 202 of the sled 100. The wheel assembly 300 is useful for providing a rolling of the sled 100 over a flat hard terrain, thereby providing an efficient and a lessening of effort to move the sled 100.

The assembly 400 has one or more harnesses 401 and one or more couplings 402. Each of the one or more harnesses 401 is coupled to one of the one or more couplings 402. The harnesses 401 have a strap 403 and a shoulder harness 404. The shoulder harness 404 is coupled to a first end 405 of the strap 403. A second end 406 of the strap 403 is securely coupled to the couplings 402. The couplings 402 are preferably a ring coupling, however other types of couplings are hereby contemplated, including, but not limited to, clips, locking, Velcro® straps, etc.

The couplings 402 are further removably and securely coupled to the front 205 of the body 200 of the sled 100 substantially near the edge 207 of the body 200 of the sled 100.

Thus to move the sled 100 after storing items into the interior 202 of the body 200 of the sled 100, the person would take the shoulder harness 404 of the assembly 400 and pull the sled 100, where the assembly 400 eases the pulling effort necessary to move the sled 100 over the sandy terrain.

Thus, to move the sled 100 after storing items into the interior 202 of the body 200 of the sled 100, the person would take the handle 501 of the sled 100 and pull the sled 100, where necessary to move the sled 100 over the flat hard terrain.

Thus, to secure items into the interior 202 of the body 200 of the sled 100, the person would secure items in the interior 202 of the body 200 of the sled 100, the person would secure items into the interior 202 of the body 200 of the sled by attaching bungee cords or a cargo net 502 which has six (6) holes, three (3) on each side of the top exterior lip 200 of the sled 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A sled for transporting items over a sandy terrain, the sled comprising:
a body, the body having a top, an edging, a front, a back, an interior and a bottom, where the interior for storing the items;
a wheel assembly, the wheel assembly having one or more wheels and one or more axles, wherein the wheels being securely coupled to the axles, and wherein the wheel assembly being coupled to the bottom of the body substantially near the back of the body; and
an assembly, the assembly having one or more shoulder harness, one or more straps and one or more couplings, wherein the shoulder harness being coupled to a first end of the straps, wherein the couplings being coupled to a second end of the strap, and wherein the couplings being securely and removably coupled to the front of the body substantially near the edging of the body.

2. The sled of claim 1, wherein the sled having a height being eighteen (18) inches.

3. The sled of claim 1, wherein the sled having a length being three (3) feet.

4. The sled of claim 1, wherein the sled having a width being two (2) feet.

5. The sled of claim 1, wherein the sled being made of a plastic material.

6. The sled of claim 1, wherein the sled further comprising an umbrella, the umbrella being removably coupled to the edging of the body substantially near the back by a coupling.

7. The sled of claim 6, wherein the coupling being a clamp.

8. The sled of claim 1, wherein the sled being a rectangular shape.

9. The sled of claim 1, wherein the wheels being a solid wheel.

10. The sled of claim 1, wherein the axle being made of an aluminum material.
